(19) United States
(12) Patent Application Publication
(10) Pub. No.: US 2011/0308046 A1
(43) Pub. Date: Dec. 22, 2011

(54) HARNESSING APPARATUS FOR ORGANIZING AND PREVENTING THE ENTANGLEMENT OF TUBES, WIRES, CABLES, AND THE LIKE

(76) Inventor: William Weiss, Riverside, CA (US)

(21) Appl. No.: 13/160,993

(22) Filed: Jun. 15, 2011

Related U.S. Application Data
(60) Provisional application No. 61/398,074, filed on Jun. 21, 2010.

(51) Int. Cl. F16G 11/04; F16G 11/00

(52) U.S. Cl. 24/122.6

(57) ABSTRACT

The present invention is a harnessing apparatus to manage, organize, and prevent the entanglement of tubes, wires, cables, and the like, comprising a base and a cover that are hingedly connected to one another and having a plurality of flexible teeth that physically separate the tubes, wires, and cables so as to keep them organized and prevent their entanglement. The preferred embodiment of the present invention relates to a harnessing apparatus that is used in a healthcare facility setting to organize and prevent the entanglement of intravenous (IV) tubes and other monitoring wires and cables connected directly to a patient. However, it is recognized that the present invention can also be configured for use with other tubes, wires, and cables in a non-healthcare facility setting, such as household appliances, computers, entertainment systems, and even the tubes and wires inside the engine of an automobile, boat, or aircraft.

### CROSS-REFERENCE TO RELATED APPLICATION

The present invention claims benefit to U.S. Provisional Application No. 61/398,074 filed Jun. 21, 2010, the entire disclosure which is herein incorporated by reference.

### BACKGROUND OF INVENTION

1. Field of Invention

The present invention is related to an apparatus and method of organizing and preventing the entanglement of tubes, wires, cables, and the like. More particularly, the invention relates to a harnessing apparatus that is used to manage, organize, and prevent the entanglement of tubes, wires, and cables. More particularly, the preferred embodiment of the present invention relates to a harnessing apparatus that is used in a healthcare facility setting to organize and prevent the entanglement of intravenous (IV) tubes and other monitoring wires and cables connected directly to a patient. However, it is recognized by those skilled in the art that the present invention can also be configured for use with other tubes, wires, and cables in a non-healthcare facility setting, such as household appliances, computers, entertainment systems, and even the tubes and wires inside the engine of an automobile, boat, or aircraft.

2. Description of Prior Art

In health care facilities all over the world, therapeutic agents, drugs, medicines, nutrients, and various other fluids are routinely introduced directly into the blood stream of patients through intravenous (IV) tubes. An IV tube is a flexible tube that allows the communication between fluid from a solution bag or bottle attached to one end of the IV tube and a hollow needle attached to the opposite end. The hollow needle is inserted into the patient's vein for the slow and continuous application of the therapeutic fluid. While this procedure is well known and normally operates without complications, monitoring the fluid and maintaining IV tubes untangled and organized can present some challenges.

A typical IV system consists of multiple IV tubes each attached to a fluid bag or bottle that serves as the source of the therapeutic fluid. The fluid bags or bottles are then suspended from a pole so as to be above the level of the patient, thus allowing gravity to flow the fluid into the IV tube and into the patient through the hollow needle. The length of the IV tubes can be substantially long so as to allow for slack, to accommodate the remote placement of the fluid bag or bottle relative to the patient, to accommodate patient movement, and to allow healthcare professionals uninhibited access to the patient.

A common length for IV tubes is about 6 to 8 feet. As such, it is common for patients to become entangled in the IV tubes risking injury and disconnection by inadvertently pulling the needle from inside their veins. The risk is higher as the patient walks, is transferred from a stretcher to a bed, is transported by an ambulance or aircraft, or during surgery or an intensive care procedure. Entanglement of the IV tubes can even occur as the patient rests or sleeps on a bed and moves around consciously or unconsciously.

When the IV tubes become entangled and/or disorganized, they become an unsightly mess and a nuisance to both the patient and the healthcare professionals. Disorganized IV tubes are prone to catch on passing persons or equipment and can be inadvertently disconnected from the patient or the fluid bag or bottle. During emergency situations, it is important to be able to quickly identify the fluid source of each IV tube connected to a patient. When the IV tubes are entangled, it becomes difficult to quickly determine which IV tube corresponds to each fluid bag or bottle. At times, certain medicines have to be injected directly into a particular IV tube. Extreme care must be exercised to make sure that the right medicine is injected into the correct IV tube. Misidentifications by healthcare professionals under pressure can be detrimental to the well-being of the patient.

This type of entanglement or disorganization of IV tubes is very common in health care facilities throughout the world. However, it is recognized that similar entanglement or disorganization problems take place with other types of tubes in a hospital setting, such as suction tubes, drainage tubes, catheters, ventilator tubes, and the like. Similar entanglement or disorganization problems also occur with cables, such as blood pressure, heart, and oxygen monitor cables. More importantly, such entanglement or disorganization problems commonly occur outside a health care facility setting with various tubes, cables, and wires, such as electrical wires and cables in home appliances, various tubes in the engine of a vehicle or aircraft, and the like.

The disentanglement, organization, and straightening of IV tubes and other wires can be accomplished through a manual effort that can consume a considerable amount of time. Thus, several devices have been invented to deal with this problem. One of the early devices was patented in 1962 as U.S. Pat. No. 3,027,419 which teaches a harnessing system that is permanently attached to the tubes or wires to maintain them in a separated state. Multiple of such permanent devices are needed through the span of long tubes or wires. As such, this is an inefficient way.

More current patents, such as U.S. Pat. Nos. 5,085,384 and 6,109,569, teach devices having a C-shaped clamp body that has a circular receiving space into which a tube, wire, or cable is inserted. The problem with this configuration is that it is size specific. Thus, different C-shaped clamps must be manufactured to accommodate different size tubes, wires, and cables. More importantly, a major disadvantage to this design is that the C-shaped clamp has an opening through which the tube, wire, or cable can slip out inadvertently. The C-shaped clamp design is simply not secure enough for the high-paced emergency environment of a medical setting.

U.S. Pat. No. 5,224,674 teaches a device having a similar C-shaped clamp as described above but with a hinged lid that then closes the opening so that the tube, wire, or cable is blocked from slipping out inadvertently. U.S. Pat. No. 5,389,082 teaches a more compact and less bulky configuration by using two cover plates each with a plurality of U-shaped grooves. The U-shaped grooves on each cover plate correspond in size, number, and position. Thus, when the cover plates are coupled together, the U-shaped grooves form essentially circular grooves that securely capture a tube, wire, or cable. Although the '674 patent and the '082 patent both secure a tube, wire, or cable in place, the C-shaped clamp and the U-shaped grooves make these devices size-specific. This means that different sizes must be manufactured to accommodate different size tubes, wires, and cables. Maintaining an inventory of different size devices can be confusing and burdensome to medical facilities.

U.S. Pat. No. 6,620,105 teaches a device that is not restricted by the size of the tube, wire, or cable. This device has a bottom component and a top component that attach together. One of the components has a plurality of sidewalls that create grooves between one another into which a tube, wire, or cable can be inserted. Once the tube, wires, or cables are in place, the top component is attached on top of the bottom component. The components have a ratcheting mechanism that allows the top component to be attached at various height positions relative to the bottom component. The ratcheting mechanism allows this device to accommodate tubes, wires, or cables of various sizes. However, the complexity of the ratcheting system makes this device costly to manufacture and difficult to use. But more important, the ratcheting system allows this device to be inadvertently squeezed too far so as to crush the tube and restrict or completely block the flow of the therapeutic fluid to the patient.

Another proposed solution is taught by U.S. Pat. No. 5,144,100. In the first embodiment, the tube or wire must be inserted into an appropriate aperture and passed through the interior of the device, since there is no lid-type component. To keep the tube or wire from moving once inserted into the device, the second embodiment provides a tether that extends across each of the inserted tubes or wires. if the diameter of the tube or wire is greater than the aperture, then the tube or wire cannot be placed within the housing. This drawback makes this device size-specific as the other devices discussed above. This drawback is addressed in the third embodiment by the inclusion of the J-shaped cover lid and the plurality of channels formed in the base of the device. This third embodiment is depicted in FIGS. 7 and 8 of the '100 patent and represents that closest prior art to the invention in this patent that the inventor has been able to locate.

As shown by its FIGS. 7 and 8, the '100 patent teaches a device having a base with a plurality of parallel ribs orthogonally mounted and defining a plurality of channels for mounting the tubes, wires, or cables therewithin. The channels are narrowed at a lowermost end for capturing each tube, wire, or cable therewithin. A J-shaped cover lid is hingedly mounted to the base so as to be able to cover the top end of the channels to prevent the tubes, wires, or cables from inadvertently slipping out. Having the channels wide toward the top and narrow toward the bottom accommodates different size tubes, wires, or cables. However, the ribs are so rigid and inflexible that it is easy for a tube to be pushed in too deep into a channel and restrict or completely block the flow of therapeutic fluid to the patient. Furthermore, the large surface area of the ribs in contact with the tube within the channels creates a substantial frictional contact thus making it very difficult to move the device over the tubes, wires, or cables so as to untangle them or to allow the tubes to move with the patient and prevent disconnection when the patient moves or inadvertently pulls the tubes.

### SUMMARY OF THE INVENTION

Accordingly, the present invention has been made in view of the above-mentioned disadvantages occurring in the prior art. The present invention is a harnessing apparatus to manage, organize, and prevent the entanglement of tubes, wires, and cables, comprising a base and a cover that are hingedly connected to one another and having a plurality of flexible teeth that physically separate the tubes, wires, and cables so as to keep them organized and prevent their entanglement.

It is therefore a primacy object of the present invention to organize and prevent the entanglement of various tubes, wires, and cables.

Another object of the present invention is to provide an apparatus that accommodates tubes, wires, and cables of various sizes without squeezing them or gripping them so as to restrict or block the flow of fluid therewithin.

Yet another object of the present invention is reduce the amount of frictional contact with the tubes, wires, and cables to facilitate the tubes, wires, and cables to slide within the harnessing apparatus to prevent them from being gripped by the apparatus and disconnected from the patient when they are inadvertently pulled.

Yet another object of the present invention is to prevent the tubes, wires, and cables to inadvertently slip out of or be removed from the apparatus.

Yet another object of the present invention is to allow the apparatus to be fully operable by a healthcare practitioner or other user with a single hand.

Yet another object of the present invention is to develop an apparatus that can be adapted to be used with various types of tubes, wires, and cables, such as those used in household appliances, computers, entertainment systems, and even those used in harsher environments such as the engines of a vehicle, boat, or aircraft.

A still further object of the present invention is to provide an apparatus that is easy and inexpensive to manufacture.

The above objects and other features and advantages of the present invention, as well as the structure of various embodiments of the present invention, are described in detail below with reference to the accompanying drawings.

### DESCRIPTION OF THE DRAWINGS

The accompanying drawings which are incorporated by reference herein and form part of the specification, illustrate various embodiments of the present invention and, together with the description, further serve to explain the principles of the invention and to enable a person skilled in the pertinent are to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of the harnessing apparatus of the present invention in its assembled state and in the closed position as it would be used with tubes, wires, cables, and the like.

FIG. 2 is a perspective view of the base of the present invention having a plurality of tall and short teeth that extend upward.

FIG. 3 is a perspective view of the cover of the present invention having a vertical wall extending downward.

FIG. 4 is a cross sectional view of the harnessing apparatus of the present invention in its assembled state and in the closed position.

FIG. 5 is a perspective view of the harnessing apparatus of the present invention in its assembled state and in the opened position as it would be used with tubes, wires, cables, and the like.

FIG. 6 shows the embodiment of U.S. Pat. No. 5,144,100 that represents the closest prior art to the present invention that the inventor has been able to locate.

### DETAILED DESCRIPTION OF THE PREFERRED EMBODIMENTS

Reference will now be made to the drawings in which various elements of the present invention will be given numerical designations and in which the invention will be discussed so as to enable one skilled in the art to make and use the invention.

The preferred embodiment of the present invention comprises a harnessing apparatus 100 to manage, organize, and prevent the entanglement of tubes, wires, and cables, comprising a base 10 and a cover 20 that are hingedly connected together at one end. It is well known that therapeutic fluids are often administered to patients in healthcare facilities through IV tubes that are narrow and can be as long as 8 feet. When multiple IV tubes are connected to a single patient, they can cause confusion by making it difficult to differentiate between the separate IV tubes. The sheer length of the IV tubes makes them easy to intertwine and entangle, especially during the transport of the patient or while the patient moves or walks. In addition to IV tubes, patients are often connected to various monitoring devices through wires and cables of different length and diameter that are also prone to entanglement. In the present invention, the base 10 has a plurality of teeth 11 and 12 that physically separate the tubes, wires, and cables from one another so as to keep them organized and prevent their entanglement.

Application of the present invention is with tubes, wires, cables, and the like. The preferred embodiment described herein has been configured to meet the needs of healthcare facilities to organize and prevent the entanglement of IV tubes and other medical monitoring wires and cables that are connected directly to patients. However, it will be appreciated by those skilled in the art that the principles of this invention may be applied to other types of tubes, wires, and cables without departing from the spirit of the present invention. The present invention can be adapted to accommodate wires and cables from household appliances, computers, entertainment systems, and the like. The present invention can also be adapted to accommodate the tubes and wires of a vehicle, boat, or aircraft.

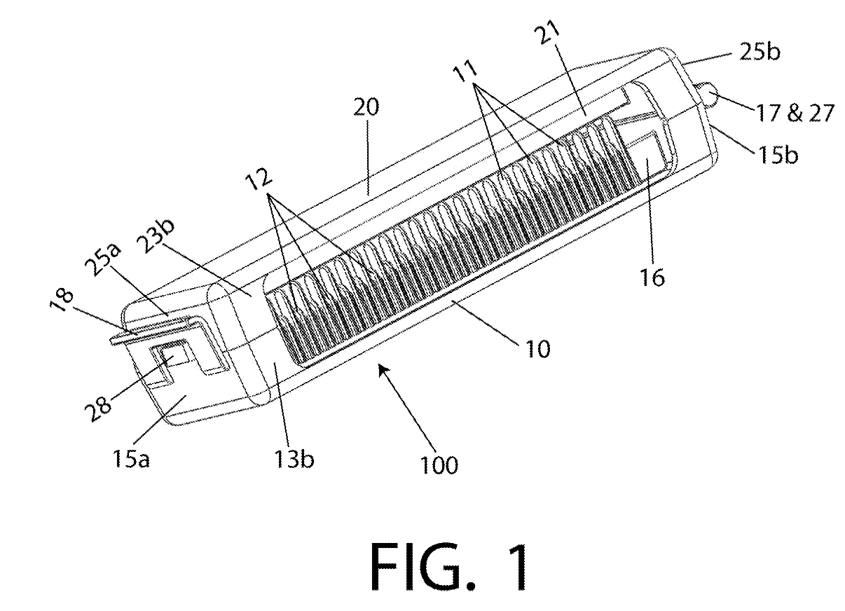

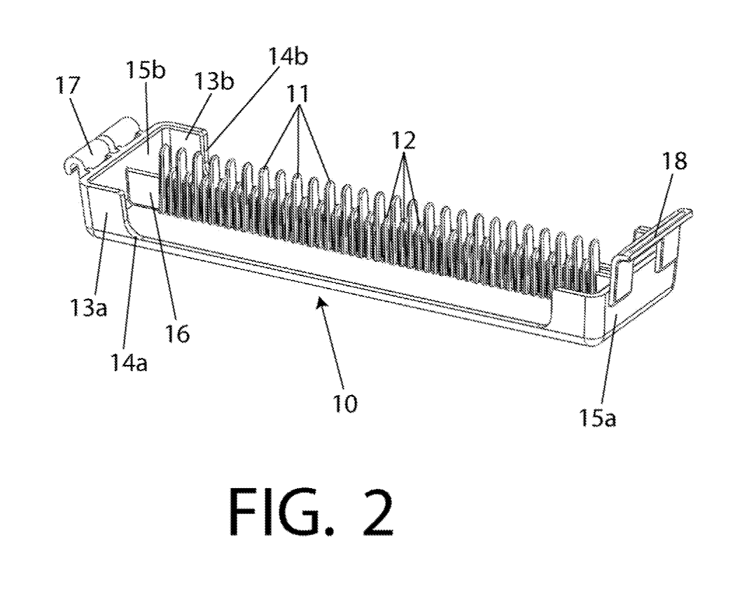

FIG. 1 shows a perspective view of the harnessing apparatus 100 of the present invention in its assembled state and in the closed position as it would be used with tubes, wires, cables, and the like. FIG. 2 shows the base 10 and depicts a plurality of tall teeth 11 and short teeth 12 that extend upward and parallel to one another. The teeth 11 and 12 are spaced apart from one another by a predetermined distance and are arranged so that a short tooth 12 is always in between two tall teeth 11. Additionally, the base 10 has a front wall 13a and a rear wall 13b both of which also extend upward and have a large opening 14a and 14b. The base 10 also has a right wall 15a and a left wall 15b both of which are of equal height as the front wall 13a and rear wall 13b. The teeth 11 and 12 are designed to be thin and flat with a width that is parallel to the right wall 15a and left wall 15b. As such, due to their small thickness, the teeth 11 and 12 have a substantial amount of flexibility in a single direction that is parallel to the front wall 13a and rear wall 13b. On the other hand, due to their width, the teeth 11 and 12 are rigid and inflexible in the direction parallel to the right wall 15a and left wall 15b. The teeth 11 and 12 are positioned along a line that is parallel to the front and rear walls 13a and 13b along the center of the base 10, as shown in FIG. 2.

Furthermore, the base 10 has a center wall 16 that extends upward through the middle of the teeth 11 and 12 so as to add some rigidity and stability to the teeth 11 and 12. The center wall 16 extends upward a fixed distance below the top of the teeth 11 and 12. Additionally, the first half of a hinge 17 protrudes outward from the left wall 15b while a flexible latch 18 protrudes out from the right wall 15a of the base 10.

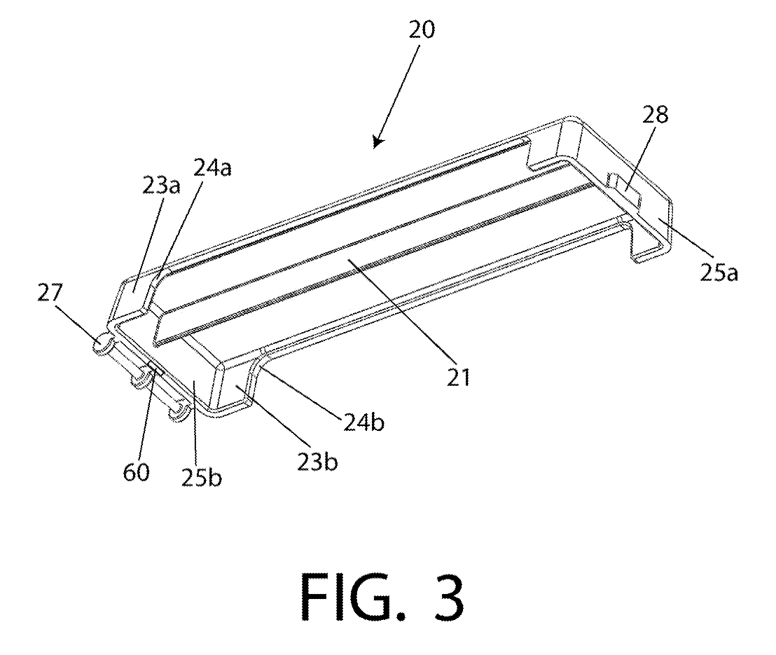

FIG. 3 shows the cover 20 that has a vertical wall 21 extending downward a fixed distance. The cover 20 also has a front wall 23a and a rear wall 23b both of which extend downward and have a large opening 24a and 24b. The cover 20 also has a right wall 25a and a left wall 25b both of which also extend downward the same distance as the front wall 23a and rear wall 23b. The vertical wall 21 is parallel to the front and rear walls 23a and 23b and extends in the same downward direction.

The second half of a hinge 27 protrudes outward from the left wall 25b. The two halves of the hinge 17 and 27 connect together to hingedly attach the cover 20 to the base 10. A tab 28 projects outward from the right wall 25a of the cover 20 and mechanically interlocks with the flexible latch 18 on the base 10 so as to lock the hinged cover 20 in the closed position on top of the base 10, as shown in FIG. 1.

Hereinafter, an explanation on the methods of assembling the product of the present invention for distribution and the operating state thereof will be given.

Assembly of the harnessing apparatus 100 of the present invention simply requires the two halves of the hinge 17 and 27 to be joined together to hingedly attach the cover 20 to the base 10. Once assembled, the cover 20 can rotate about the hinge so as to open and close the harnessing apparatus 100. The harnessing apparatus 100 is in the closed position when the cover 20 is rotated to sit on top of the base 10 as shown in FIG. 1. When the cover 20 is on top of the base 10, the tab 28 interlocks with the flexible latch 18 to hold or lock the cover 20 in the closed position. Packaging and distribution of the harnessing apparatus 100 of the present invention occurs with the cover 20 hingedly attached to be base 10 and held or locked in the closed position, as shown in FIG. 1.

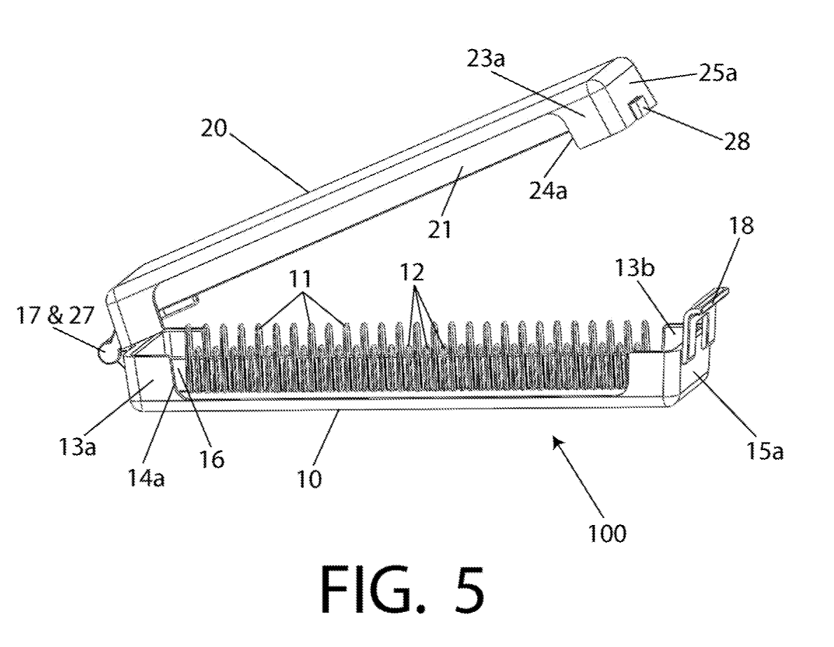

The first step in using the harnessing apparatus 100 of the present invention is opening it so that tubes, wires, and cables can be placed in between the cover 20 and the base 10. Opening the harnessing apparatus 100 is accomplished by pushing or pulling the flexible latch 18 until it is disengaged from the tab 28. Once the tab 28 and flexible latch 18 are disengaged, the cover 20 can be rotated about the hinge to open the harnessing apparatus 100 and expose the teeth 11 and 12, as shown in FIG. 5.

When the harnessing apparatus 100 is opened and the teeth 11 and 12 are exposed, various tubes, wires, and cables can be inserted in between the teeth 11 and 12. As previously described, the teeth 11 and 12 are arranged along a single line parallel to the front wall 13a in the center of the base 10 with a short tooth 12 always in between two tall teeth 11. As such, the larger tubes, wires, and cables are placed between two tall teeth 11. The teeth 11 and 12 are designed to flex in a single direction that is parallel to the front and rear walls 13a and 13b so as to accommodate the larger tubes, wires, or cables. Thus, the tall teeth 11 flex to allow the larger tubes to be placed between them while they squeeze the tubes slightly so as to hold on to them without blocking or restricting the flow of fluid therewithin. On the other hand, the smaller tubes, wires, or cables can be pushed in between a tall tooth 11 and a short tooth 12.

The short teeth 12 also play an important role when inserting larger tubes in between the tall teeth 11. The short teeth 12, in essence, serve as stops to block or stop tubes from being pushed too deep in between the tall teeth 11. As previously, discussed, the tall teeth 11 are designed to be flexible so as to prevent the tubes from being squeezed so much that the flow of fluid therewithin is restricted or blocked. However, the lowermost portion of the tall teeth 11 is inflexible as it is rigidly attached to the base 10. As such, the small teeth 12 are located between two tall teeth 1.1 to prevent a tube that is inserted between the two tall teeth 11 from being pushed in too deep where the inflexibility of the tall teeth 11 would restrict or block the flow of fluid therewithin.

Once all the tubes, wires, and cables are placed within the teeth 11 and 12, the cover 20 is rotated about the hinge to the closed position. To lock the cover 20 in the closed position, it is pushed all the way against the base 10 until the tab 28 interlocks with the flexible latch 18. The flexible latch 18 is designed with sufficient flexibility to be bent or displaced by the tab 28 as the cover 20 is pushed against the base 10 until the flexible latch 18 engages the tab 28 and the cover 20 is locked in place.

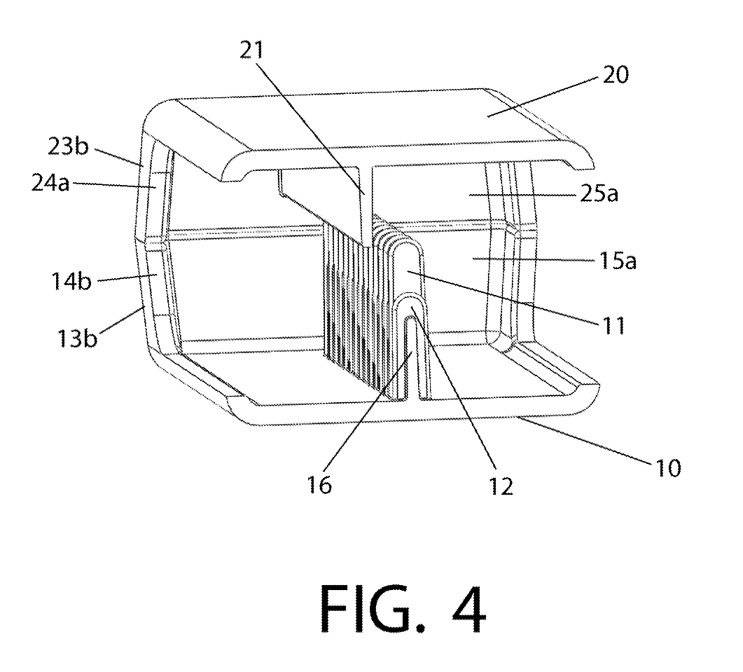

Once the cover 20 is locked in the closed position, the vertical wall 21 of the cover 20 extends down to or just below the top of the tall teeth 11 to prevent the tubes, wires, and cables from slipping out of or being inadvertently removed from between the teeth 11 and 12. In essence, the vertical wall 21 blocks or closes the opening that is between the top of the tall teeth 11. To prevent any physical interference between the vertical wall 21 and the teeth 11 and 12, the vertical wall 21 is designed to be parallel to the center wall 16 but off to one side or away from the teeth 11 and 12, as shown in FIG. 4.

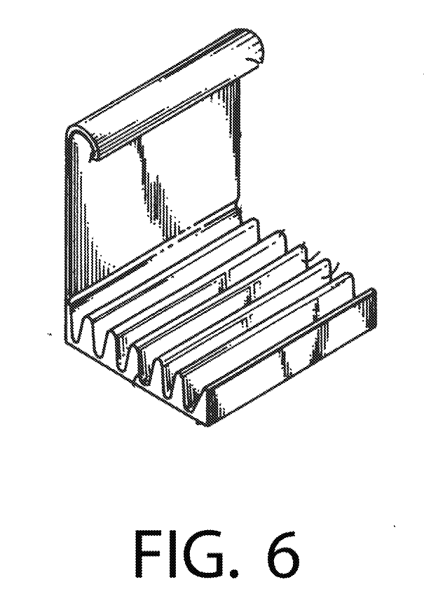

As such, a significant difference between the harnessing apparatus 100 of the present invention and the embodiment shown in FIGS. 7 and 8 of U.S. Pat. No. 5,144,100, as shown in FIG. 6, is that the teeth 11 and 12 of the present invention are flexible unlike the parallel ribs of the '100 patent. Thus, if a tube is pushed in between the tall teeth 11, then the tall teeth 11 will flex open so as not to restrict or block the flow of therapeutic fluid to the patient. The short teeth 12 are specifically placed in between two tall teeth 11 to stop or prevent a tube from being pushed in too deep into the inflexible lowermost portions of the tall teeth 11. In addition, the amount of surface area of the tubes, wires, and cables in contact with the teeth 11 and 12 of the present invention is small compared to the amount of surface area in contact with the parallel ribs of the '100 patent. Thus, less friction holds the tubes in place in the present invention to allow the tubes to slide within the harnessing apparatus 100. This is important because when the patient inadvertently pulls the tubes too much, the harnessing apparatus 100 of the present invention allows the tubes to slide and move with the patient as opposed to gripping the tubes and risking them from being disconnected from the patient as with the '100 patent.

Secondly, the preferred embodiment of the harnessing apparatus 100 of the present invention is designed with a narrow profile so as to allow it to be attached to or mounted on the rail of a hospital bed, the pole of an IV tube holder, or the like. To facilitate the mounting of the harnessing apparatus 100 of the present invention, the preferred embodiment has a strip of the hook portion of Velcro attached or molded on the bottom of the base 10. Said hook portion of Velcro attaches on to a strip of the loop portion of Velcro that is attached on a hospital bed rail, IV holder pole, and the like. Said hook and loop portions of Velcro allow the harnessing apparatus 100 of the present invention to be attached and detached quickly and easily from bed rails, IV poles, and the like.

Thirdly, the preferred embodiment of the harnessing apparatus 100 of the present invention has a paper label attached on top of the cover 20. After placing the tubes, wires, and cables in the harnessing apparatus 100 and locking the cover 20 in the closed position, a healthcare practitioner can write down on the paper label marks to identify each of said tubes, wires, and cables. When the harnessing apparatus 100 is used with another patient or with different tubes, wires, or cables, a healthcare practitioner can either attach a new paper label on top of the marked-up label on the cover 20 or he/she can remove the marked-up label and attach a new paper label.

Fourth, the preferred embodiment of the harnessing apparatus 100 of the present invention has a wedge 60 that projects downward from the bottom of the left wall 25b of the cover 20. Said wedge 60 projects a very small distance enough to create a gap or separation between the cover 20 and base 10. When the tab 28 is disengaged from the flexible latch 18, the wedge 60 pushes the cover 20 upward relative to the base 10 so as to automatically open the harnessing apparatus 100 of the present invention.

Therefore, the preferred embodiment of the harnessing apparatus 100 of the present invention is essentially designed for single-handed operation by a healthcare practitioner. When the harnessing apparatus 100 is locked in the closed position, the healthcare practitioner, with a single hand, pushes against the flexible latch 18 until it is disengaged from the tab 28 on the cover 20. Once the tab 28 and flexible latch 18 are disengaged, the wedge 60 immediately pushes the cover 20 open so as to expose the teeth 11 and 12. Then, a healthcare practitioner, with a single hand, can place various tubes, wires, and cables between the teeth 11 and 12 of the harnessing apparatus 100. Finally, the healthcare practitioner, with a single hand, can close and push on the cover 20 until the tab 28 interlocks with the flexible latch 18 so as to lock the cover 20 in the closed position.

To reduce the cost of manufacturing and to facilitate its use in a healthcare facility setting, the preferred embodiment of the harnessing apparatus 100 of the present invention is made of flexible plastic material. However, those skilled in the art will recognize that the harnessing apparatus 100 can be built from different materials and of different sizes to accommodate other types of tubes, wires, and cables than those used in a healthcare facility setting. The harnessing apparatus 100 can be adapted to accommodate tubes, wires, and cables from household appliances, computers, entertainment systems, and the like. It can also be adapted to accommodate tubes, wires, and cables of a vehicle, boat, or aircraft.

An alternative embodiment of the harnessing apparatus 100 of the present invention has the teeth 11 and 12 extending downward from the cover 20 rather than upward from the base 10 Another alternative embodiment may have only one set of teeth, either the tall teeth 11 or the short teeth 12. Yet another alternative embodiment does not have the cover 20 hingedly attached to the base 10, rather the cover 20 and the base 10 are two separate components that can clamp or attach on to one another in the closed position. Finally, yet another alternative embodiment does not have the vertical wall 21 to block or close the openings between to the top of the teeth 11 or 12. Instead, the cover 20 can be designed so that it abuts the top of the teeth 11 or 12 in the closed position. The disadvantages of this configuration, however, is that it may interfere with the teeth 11 or 12 so as to make it difficult to lock the cover 20 in the closed position, and it may reduce the amount of vertical space available for the tubes, wires, and cables to move.

It is understood that the described embodiments of the harnessing apparatus 100 of the present invention are illustrative only, and that modifications thereof may occur to those skilled in the art. Accordingly, the invention is not to be regarded as limited to the embodiments disclosed, but to be limited as defined by the appended claims herein.

What is claimed is:

1. A harnessing apparatus for organizing a plurality of tubes, wires, cables, and the like, to reduce tangling and facilitate identification of each, said harnessing apparatus comprising:
a base having a plurality of flexible teeth extending parallel to one another and spaced apart by a predetermined distance;
said flexible teeth configured for releasably and frictionally retaining therein said plurality of tubes, wires, cables, and the like; and
a cover detachably coupled to said base over said flexible teeth so that said tubes, wires, cables, and the like, are retained within said harnessing apparatus.

2. The harnessing apparatus as defined in claim 1, wherein said cover is hingedly attached to said base.

3. The harnessing apparatus as defined in claim 2, further comprising a locking means at one end of said cover and said base that locks said cover on top of said base to retain said tubes within said harnessing apparatus.

4. The harnessing apparatus as defined in claim 3, wherein said locking means comprises a flexible latch attached to said base and that interlocks with a tab projecting outward from said cover.

5. The harnessing apparatus as defined in claim 3, further comprising a wedge that projects downward from said cover to create interference between said cover and said base such that when said cover is unlocked from the top of said base, said wedge pushes said cover upward relative to the base so as to automatically open said harnessing apparatus.

6. The harnessing apparatus as defined in claim 1, wherein said plurality of flexible teeth comprises tall teeth and short teeth aligned along a line across said base wherein one of said short teeth is positioned in between two of said tall teeth.

7. The harnessing apparatus as defined in claim 1, wherein said plurality of flexible teeth are thin and narrow to allow said flexible teeth to flex only in a direction transverse to said tubes, wires, cables, and the like.

8. A harnessing apparatus for organizing a plurality of tubes, wires, cables, and the like, to reduce tangling and facilitate identification of each, said harnessing apparatus comprising:
a base having a plurality of flexible teeth extending parallel to one another and spaced apart by a predetermined distance;
said flexible teeth configured for releasably and frictionally retaining therein said plurality of tubes, wires, cables, and the like;
said flexible teeth built thin and narrow to allow said flexible teeth to flex only in a direction transverse to said tubes, wires, cables, and the like; and
retaining means that retains said tubes, wires, cables, and the like within said harnessing apparatus.

9. The harnessing apparatus as defined in claim 8, wherein said cover is hingedly attached to said base.

10. The harnessing apparatus as defined in claim 9, further comprising a locking means at one end of said cover and said base that locks said cover on top of said base to retain said tubes within said harnessing apparatus.

11. The harnessing apparatus as defined in claim 10, wherein said locking means comprises a flexible latch attached to said base and that interlocks with a tab projecting outward from said cover.

12. The harnessing apparatus as defined in claim 10, further comprising a wedge that projects downward from said cover to create interference between said cover and said base such that when said cover is unlocked from the top of said base, said wedge pushes said cover upward relative to the base so as to automatically open said harnessing apparatus.

13. The harnessing apparatus as defined in claim 8, wherein said plurality of flexible teeth comprises tall teeth and short teeth aligned along a line across said base wherein one of said short teeth is positioned in between two of said tall teeth.
